(19) United States
(12) Patent Application Publication
(10) Pub. No.: US 2025/0176078 A1
(43) Pub. Date: May 29, 2025

(54) Method of Setting a Microwave Power

(71) Applicant: RATIONAL Aktiengesellschaft, Landsberg am Lech (DE)

(72) Inventors: Simone ROESLER, Landsberg am Lech (DE); Thomas SCHREINER, Landsberg am Lech (DE); Bernhard SCHÜHLER, Landsberg am Lech (DE); Moritz BERRES, Landsberg am Lech (DE); Peter MÜLLER, Landsberg am Lech (DE)

(21) Appl. No.: 18/958,528

(22) Filed: Nov. 25, 2024

(30) Foreign Application Priority Data
Nov. 29, 2023 (DE) 10 2023 133 430.1

(51) Int. Cl. H05B 6/68; H05B 6/64

(52) U.S. Cl. CPC H05B 6/687; H05B 6/6435; H05B 6/645; H05B 6/6458; H05B 6/6485

(57) ABSTRACT

Embodiments of the present disclosure relate to a method of setting a microwave power in a cooking appliance, comprising the steps of:
specifying a microwave factor;
introducing a thermal energy into a cooking chamber of the cooking appliance;
determining a heat consumption of the thermal energy in the cooking chamber; and
setting the microwave power on the basis of the microwave factor and the thermal heat consumption in the cooking chamber.

Further, embodiments of the present disclosure relate to a cooking appliance.

### CROSS-REFERENCE TO RELATED APPLICATIONS AND PRIORITY

This patent application claims priority from German Patent Application No. 10 2023 133 430.1 filed Nov. 29, 2023. This patent application is herein incorporated by reference in its entirety.

### FIELD OF THE DISCLOSURE

Embodiments of the present disclosure relate to a method of setting a microwave power in a cooking appliance. Further, embodiments of the present disclosure relate to a cooking appliance.

### BACKGROUND

In professional or canteen kitchens, cooking appliances are used which are adapted to cook a cooking product present in a cooking chamber of the cooking appliance in different ways. In addition to the conventional methods in which the cooking product is cooked using hot air and/or steam, modern cooking appliances often also use microwave sources which introduce energy into the cooking product by means of electromagnetic radiation to (additionally) heat the cooking product. Vacuum tubes (magnetrons, for example) and semi-conductor components can be used as microwave sources.

In many conventional cooking appliances, the microwave power has to be specified by the user for each cooking process. For example, the user can set the microwave power in stages between 0% and 100% on the appliance. A setting of the maximum level or 100% usually results in the microwave source radiating into the cooking chamber at its full nominal power (e.g. 2 KW).

During setting, the user must decide for itself which microwave power is optimal for the cooking process. The user must take influencing factors such as the load quantity and the degree of heating into account based on its experience and/or its own assessment. Setting an optimal microwave power is therefore associated with great effort and also prone to errors.

If the microwave power is too low, the cooking process can take unnecessarily long. However, if the microwave power is set too high, this may lead to a drying out, insufficient crust formation and/or poor energy efficiency of the cooking process.

### SUMMARY

The object of the present disclosure is therefore the provision of a simple and cost-effective possibility of preventing incorrect settings of the microwave power during cooking, in particular in manual cooking processes, and to thus ensure a good and reproducible cooking result.

According to the present disclosure, the object is achieved by a method of setting a microwave power in a cooking appliance. The method comprises the steps of:
specifying a microwave factor M;
introducing a thermal energy into a cooking chamber of the cooking appliance;
determining a heat consumption of the thermal energy in the cooking chamber; and
setting the microwave power P_{MW} on the basis of the microwave factor M and the thermal heat consumption in the cooking chamber.

The term “heat consumption”, also called heat loss, refers to a consumption of the heat energy in the cooking chamber, for example a consumed proportion of the thermal energy introduced into the cooking chamber or a consumed proportion due to the introduction of a cooled (frozen) cooking product. In particular, it may also be the proportion which is consumed in a certain time in or by the cooking chamber. The heat consumption may (also) occur due to the absorption of thermal energy by the cooking product. This is the typical case in a running process, provided that no additional cooking product is introduced.

The basic idea is to set the microwave power as a relative value depending on the heat consumption in the cooking chamber, rather than as an absolute value.

A user-friendly and self-regulating system is thus created which is adapted to react dynamically to changes in the loading quantity and/or in the load in the cooking chamber.

Unnecessarily high microwave powers and/or temperatures in the cooking chamber which may lead to damage to the components, in particular with small loads, are also reliably avoided by the heat consumption-dependent dosage of the microwave radiation.

Due to the setting as a relative value, the microwave power can furthermore also automatically be taken into account when controlling the temperature in the cooking chamber. It can thus be increased or reduced synchronously with the heating power of further assemblies of the cooking appliance, which also contributes to improving the cooking quality and/or avoiding unsuccessful cooking processes. These assemblies may also introduce energy into the cooking product. They involve, for example, an infrared heating source, a hot-air source and/or a steam source, also referred to as steam generator.

A control and/or evaluation unit is in particular provided, which determines the heat consumption and sets the microwave power P_{MW} based on the microwave factor M and the thermal heat consumption in the cooking chamber, in particular of the cooking product.

One aspect of the present disclosure provides that the heat consumption is characterized by a heat consumption power P_{Abs}. The proportion of the heat consumption power P_{Abs} which is directly absorbed by the cooking product, is also referred to as power P_{GG} absorbed in the cooking product. In other words, the focus is not on a total amount of energy consumed, but on how much energy or heat is consumed in a certain time in the cooking chamber or by the cooking product. It has been shown that the heat consumption power is very well suited as a reference value for setting the microwave power, as, on the one hand, it contains important information about the cooking state of the cooking product (a colder cooking product usually absorbs thermal energy faster than a warmer one) and, on the other hand, it can be determined in a reliable and reproducible way.

In one preferred embodiment, the microwave power is set to a value which corresponds to a product of the heat consumption power, in particular the power P_{GG} absorbed by the cooking product, and the microwave factor (P_{MW}=M*P_{GG}). This is technically particularly simple to implement and less prone to errors.

The heat consumption, in particular the heat consumption power, may be determined based on an average heating power of at least one heating device of the cooking appliance. In this context, it is conceivable that during a cooking operation, the cooking chamber temperature is kept at least approximately constant over a time period. The total average heating power applied during this period of time by the radiating heating device(s) then corresponds directly (except for any power losses) to the heat consumption power.

Additionally of alternatively, the heat consumption or the heat consumption power may also be determined based on a temperature change and/or a humidity change in the cooking chamber. To this end, in particular temperature and/or humidity sensors may be used which are typically anyway provided in conventional cooking appliances. Further specific hardware is thus not required.

Ideally, the heat consumption is determined from a combination of the heating activity and the change in temperature and/or humidity.

In one variant of the method, it is provided that the heat consumption or the heat consumption power is determined based on a heating power introduced into the cooking chamber.

On the basis of the heat consumption power of the loaded cooking chamber, it is in turn possible to determine the power absorbed by the cooking product by taking any power loss into account. The power loss may be a proportion of the introduced power which leads to a heating of the cooking chamber casing (also referred to as casing loss below) and is therefore no longer available for heating the cooking product.

In simple terms, the heat consumption or the heat consumption power used as a reference value for setting the microwave power may thus be the proportion of the introduced thermal power which is actually absorbed by the cooking product.

The power loss taken into account in the method may be a specified and/or experimentally determined value.

In particular, casing losses may be determined in independent tests depending on the appliance and/or may be stored in a memory of the cooking appliance. The experimentally determined power loss values may then simply be retrieved from the memory to determine the heat consumption.

Of course, more than one power loss value may be stored in the memory of the cooking appliance.

It is in particular conceivable that the power loss is a value which depends on the course of the cooking chamber temperature. For example, in the case of a heating cooking chamber (dynamic case), power loss values are to be expected, as is this case, a large proportion of the introduced energy leads to a heating of the cooking chamber itself, in particular of the cooking chamber casing, and is thus not available for the direct heating of the cooking product. The power losses depend on the previously set cooking chamber temperature and/or on the temperature change. However, in the stationary or static case, i.e. when maintaining a specified cooking chamber temperature and assuming a heated casing, the thermal power loss only depends on the temperature-dependent heat transfer coefficient of the casing and the difference between the cooking chamber temperature and the ambient temperature.

To take this into account, a plurality of power loss values which are to be expected at different cooking chamber temperatures may be stored in the memory of the cooking appliance.

A further aspect of the present disclosure provides that an operating state of one or of a plurality of fan wheel(s) of the cooking appliance is taken into account when determining the heat consumption.

In many modern cooking appliances, changes in the direction of rotation of the fan are provided for homogenizing the cooking chamber climate. They may lead to a modified air flow and thus to changes in the measured cooking chamber temperature and/or to a modified heat consumption of the cooking product. The accuracy of the method may be improved by accordingly taking the operating state of the fan wheel(s) into account, for example the current direction of rotation and/or changes in the direction of rotation.

In a further variant of the method, the microwave factor can be specified by a user. It is conceivable that the user enters the microwave factor as a numerical value via an input device or can select it from a specified selection. In this way, the user keeps control over the cooking process. It is at the same ensured that no significant over-or under-dosage of the microwave power may occur.

For certain cooking processes, the microwave factor may be fixed, as the cooking product-specific optimum microwave factor has already been determined (experimentally) by the cooking appliance manufacturer in a preceding development process. Such cooking processes may be so-called intelligent or cooking product-specific cooking processes.

Furthermore, the present disclosure relates to a cooking appliance comprising a cooking chamber and at least one microwave module which is configured and set up to feed electromagnetic radiation into the cooking chamber to cook a cooking product introduced into the cooking chamber by means of microwave energy. The cooking appliance has a control and/or evaluation unit which is configured and set up to execute a computer program with program code means for carrying out a method according to the present disclosure. The advantages discussed in relation with the method correspondingly apply to the cooking appliance.

### BRIEF DESCRIPTION OF THE DRAWINGS

Further features and advantages of the present disclosure will become apparent from the description below and from the drawings to which reference is made and in which:

FIG. 1 shows a schematic representation of a cooking appliance according to an exemplarily embodiment of the present disclosure, loaded with a cooking product; and

FIG. 2 shows a graphical plot of microwave power curves against a heat consumption power.

### DETAILED DESCRIPTION

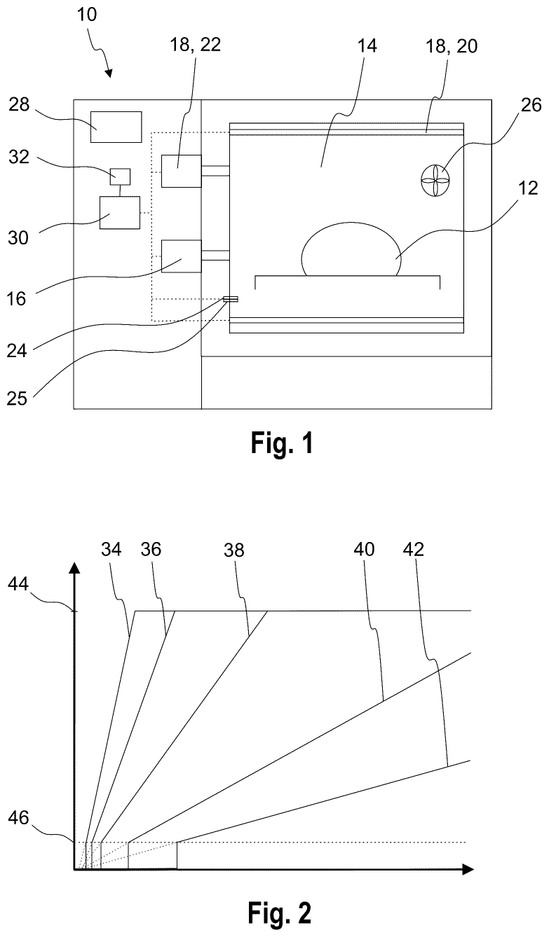

FIG. 1 shows an example embodiment of a cooking appliance 10 according to an exemplarily embodiment of the present disclosure, which is loaded with a cooking product 12 to be cooked. The cooking appliance 10 has a cooking chamber 14 and at least one (preferably a plurality of) microwave module(s) 16. For the sake of simplicity, only one microwave module 16 is illustrated in FIG. 1.

The at least one microwave module 16 comprises a solid state microwave generator (SSMG) and is configured and set up to feed microwave beams into the cooking chamber 14. The microwave beams can have a frequency which is adapted to heat the cooking product 12 present in the cooking chamber 14. The frequency is for example between 2.1 GHZ and 2.8 GHZ, in particular between 2.4 GHz and 2.5 GHZ, preferably about 2.45 GHz.

For feeding into the cooking chamber 14, the at least one microwave module 16 can be equipped with an antenna and a directional coupler (not shown). However, it is also possible to provide several antennas and directional couplers for each microwave module 16.

Furthermore, the at least one microwave module 16 can comprise further components or parts, for example a modulator, an amplifier, a demodulator and/or a controller (not shown).

In the example embodiment, the cooking appliance 10 is a combination appliance which, in addition to the at least one microwave module 16, has different additional assemblies for cooking the cooking product 12, in particular thermal heating devices 18 such as an infrared heating source 20 and a hot-air and/or steam source 22. Of course, this is not to be understood in a restrictive manner. Other types of heating devices 18 are also conceivable.

Furthermore, the cooking appliance 10 comprises at least one temperature sensor 24 by means of which the cooking chamber temperature can be detected, an optional humidity sensor 25 for detecting a humidity in the cooking chamber 14, and a reversibly operable fan wheel 26 by means of which the cooking chamber atmosphere can be mixed.

In addition, the cooking appliance 10 shown in FIG. 1 has an input device 28, for example a touch display, by means of which a user can make inputs, in particular to choose a cooking program (manually) or to set and/or adapt desired cooking parameters.

Furthermore, the cooking appliance 10 in the example embodiment has a control and/or evaluation unit 30 connected to the at least one microwave module 16, and a memory 32 in which a computer program with program code means is stored. When the computer program is executed by a processor unit (not shown) of the cooking appliance 10, it causes the control and/or evaluation unit 30 to carry out a method of setting a microwave power. This method is described in more detail below.

At the beginning of the method, a cooking product 12 is introduced into the cooking chamber 14 of the cooking appliance 10 or is already present there.

In a first step of the method, a microwave factor M is specified. This can be done in particular by an entry of a user by means of the input device 28. The microwave factor M is for example a numerical value which the user enters manually or selects from a plurality of specified numerical values.

The user can in particular make the input prior to the start of a cooking process. Alternatively, an input during a running cooking process is also conceivable.

For certain cooking processes, the microwave factor M can be fixed, as the cooking product-specific optimum microwave factor has already been determined (experimentally) by the cooking appliance manufacturer in a preceding development process. These specific cooking processes can be so-called intelligent or cooking product-specific cooking processes.

In a second step of the method, a thermal energy is introduced into a cooking chamber 14 of the cooking appliance 10 by means of the thermal heating devices 18. Of course, not all heating devices 18 described above have to be active simultaneously. It is for example sufficient if only the infrared heating source 20 or only the hot-air and/or the steam source 22 introduces a thermal energy into the cooking chamber 14.

In a third step of the method, the control and/or the evaluation unit 30 determines a heat consumption of the thermal energy in the cooking chamber 14.

In the example embodiment, the control and/or evaluation unit 30 determines to this end a heat consumption power P_{Abs} which characterizes the heat consumption in the cooking chamber 14.

In simple terms, the control and/or evaluation unit 30 thus for example determines which proportion of the introduced thermal energy is consumed within a certain time in or by the cooking chamber 14.

In the example embodiment, the heat consumption or heat consumption power is determined on the basis of an average heating power of the active heating device(s) 18 of the cooking appliance 10. To this end, an electrical energy absorbed for operating the infrared heating source 20 and/or the hot-air or steam source 22 (depending on which heating device(s) 18 is/are active) is for example detected and evaluated.

Alternatively, the heat consumption or heat consumption power can also be determined based on a temperature and/or humidity change in the cooking chamber 14 which can be determined by means of the temperature sensor 24 or the humidity sensor 25.

It is also possible to combine both variants for determining the heat consumption in the cooking chamber 14.

In the example embodiment, the control and/or evaluation unit 30 determines the power P_{GG} absorbed by the cooking product 12 from the heat consumption power and a power loss P_{V} of the cooking appliance 10.

The power loss is the proportion of the total thermal power introduced into the cooking chamber 14 which does not directly contribute to the cooking of the cooking product 12 (for example casing losses).

In the example embodiment, the power loss depends on the cooking chamber temperature. It is therefore taken into account by the control and/or evaluation unit 30 in the method as a function of the temperature in the cooking chamber. To this end, power loss values determined experimentally for different cooking chamber temperatures are stored in the memory 32 of the cooking appliance 10. The appropriate power loss value is retrieved from the memory 32 depending on which cooking chamber temperature currently prevails or is measured by the temperature sensor 24.

The power P_{GG} absorbed by the cooking product 12 can then be calculated as a difference between the heat consumption power P_{Abs} and the power loss P_{V}, in particular on the basis of the formula: P_{GG}=P_{Abs}−P_{V}.

Furthermore, the operating state of the fan wheel 26 (for example a change in the direction of rotation or a stirring power) can also be explicitly taken into account when determining the heat consumption or the heat consumption power. However, the operating state of the fan wheel 26 can also be taken into account indirectly, in particular through the influence of the fan wheel operation on the heat consumption in the cooking chamber 14. By means of the fan wheel 26, an air layer enveloping the cooking product 12 can be swirled, i.e. a so-called microclimate in the cooking chamber 14.

In a fourth step of the method, the control and/or evaluation unit 30 sets the microwave power P_{MW} on the basis of the microwave factor M and the thermal heat consumption or the heat consumption power in the cooking chamber 14, in particular the power absorbed by the cooking product 12.

In the example embodiment, it calculates to this end a value in accordance with the formula P_{MW}=M*P_{GG}, which corresponds to a product of the power P_{GG} absorbed by the cooking product 12 and the microwave factor M, and adjusts the power of the at least one microwave module 16 such that it radiates microwaves into the cooking chamber 14 with the calculated power value.

FIG. 2 schematically shows possible microwave power curves as a function of the heat consumption power for different microwave factors.

In the example embodiment, the microwave power P_{MW} is directly proportional to the power P_{GG} absorbed by the cooking product 12. The proportionality factor is the microwave factor M. For example, the following formula relationship may be given: P_{MW}=M*P_{GG}=M*P_{Abs}−M*P_{V}. As already explained above, P_{Abs} is the thermal power absorbed in the cooking chamber 14, and P_{V} is the power loss.

In this case, the slope of the microwave power curves illustrated in FIG. 2 corresponds to the microwave factor.

FIG. 2 shows a first microwave power curve 34 in which the microwave factor is 1. A second microwave power curve 36 is shown, in which the microwave factor is 0.5. In a third microwave power curve 38 shown, the microwave factor is 0.25, in a fourth microwave power curve 40 shown, the microwave factor is 0.1, and in a fifth microwave power curve 42 shown, the microwave factor is 0.05.

As can be seen from FIG. 2, the user can thus determine how quickly or strongly the microwave power can increase in a cooking process by specifying the microwave factor M.

Of course, this increase cannot take place in an unlimited manner. In FIG. 2, the microwave power curves are limited upwards by the nominal power 44 of the at least one microwave module 16 (2 KW, for example).

As shown in FIG. 2, a threshold value 46 for the microwave power can also be provided downwards. It is thus conceivable that the at least one microwave module 16, for technical and/or energy efficiency reasons, only feeds microwaves into the cooking chamber 14, when the lower threshold value 46 is exceeded.

In the example embodiment, this can be implemented in practice in that the at least one microwave module 16 is only activated when the product of the microwave factor and the heat consumption power results in a value which is above the threshold value 46. Alternatively, it is also possible to realize microwave powers below the threshold by a suitable clocking of the microwave module 16.

1. A method of setting a microwave power in a cooking appliance, comprising the steps of:
specifying a microwave factor;
introducing a thermal energy into a cooking chamber of the cooking appliance;
determining a heat consumption of the thermal energy in the cooking chamber; and
setting the microwave power on the basis of the microwave factor and the thermal heat consumption in the cooking chamber.

2. The method according to claim 1, wherein the heat consumption is characterized by a heat consumption power.

3. The method according to claim 2, wherein the microwave power is set to a value corresponding to a product of the heat consumption power and the microwave factor.

4. The method according to claim 1, wherein the heat consumption is determined based on an average heating power of at least one heating device of the cooking appliance and/or the heat consumption is determined based on a temperature change in the cooking chamber.

5. The method according to claim 1, wherein the heat consumption is determined based on a heating power introduced into the cooking chamber and a power loss of the cooking appliance.

6. The method according to claim 5, wherein the power loss is a specified value.

7. The method according to claim 5, wherein the power loss is an experimentally determined value.

8. The method according to claim 5, wherein the power loss is retrievable from a memory of the cooking appliance.

9. The method according to claim 5, wherein the power loss is a value which depends on the cooking chamber temperature.

10. The method according to claim 1, wherein an operating state of at least one fan wheel of the cooking appliance is taken into account when determining the heat consumption.

11. The method according to claim 1, wherein the microwave factor is adapted to be specified by a user.

12. The method according to claim 1, wherein the microwave factor is specified by an appliance manufacturer for specific cooking processes.

13. The method according to claim 12, wherein the microwave factor specified by the appliance manufacturer for specific cooking processes is adaptable only to a small extent by the user.

14. A cooking appliance comprising a cooking chamber, at least one microwave module which is configured and set up to feed electromagnetic radiation into the cooking chamber to cook a cooking product introduced into the cooking chamber by means of microwave energy, and a control and/or evaluation unit which is configured and set up to execute a computer program with program code means for carrying out a method according to claim 1.
